(19) United States
(12) Patent Application Publication
(10) Pub. No.: US 2018/0012491 A1
(43) Pub. Date: Jan. 11, 2018

(54) DEVICE AND METHOD FOR MANAGING INTERNET OF VEHICLES, AND VEHICLE

(71) Applicant: BOE Technology Group Co., Ltd, Beijing (CN)

(72) Inventors: Jiantao Liu, Beijing (CN); Xinan Wang, Beijing (CN); Jingjing Mu, Beijing (CN)

(21) Appl. No.: 15/515,308

(22) PCT Filed: Oct. 14, 2016
(86) PCT No.: PCT/CN2016/102137

§ 371 Date: Mar. 29, 2017

(30) Foreign Application Priority Data
Oct. 29, 2015 (CN) 201510718316.9

(51) Int. Cl. G08G 1/0967

(52) U.S. Cl. CPC G08G 1/096716; G08G 1/09675; G08G 1/096791

(57) ABSTRACT

A device and method for managing internet of vehicles are disclosed. The device is applied in a first vehicle or a second vehicle, and when the device is applied in the first vehicle, the device includes: a first receiver configured to receive a traffic request signal for requesting traffic data of the first vehicle from a second vehicle; and a first transmitter connected to the first receiver and configured to send the traffic data corresponding to real-time traffic information acquired by a traveling recording device of the first vehicle to the second vehicle. When the device is applied in the second vehicle, the device includes: a second transmitter configured to send a traffic request signal for requesting traffic data from a second vehicle to the first vehicle; and a second receiver configured to receive traffic data returned from the first vehicle in response to the traffic request signal.

### CROSS-REFERENCE TO RELATED APPLICATIONS

The present application is based on International Application No. PCT/CN2016/102137, filed on Oct. 14, 2016, which is based upon and claims priority to Chinese Patent Application No. 201510718316.9, filed Oct. 29, 2015, the entire contents of which are incorporated herein by reference.

### TECHNICAL FIELD

The present disclosure relates to the field of communication and computer technology, and more particularly to a device and method for managing internet of vehicles, and a vehicle using the device for managing internet of vehicles.

### BACKGROUND

With the improvement of people's living standards, vehicles have become a common tool for people to travel, but traffic safety has always been a matter of concern. Especially, the overtaking is the most prone to traffic accidents, resulting in damage to people and/or property. When a behind vehicle is overtaking a front vehicle by changing lanes, since the driver's line of sight in the behind vehicle may be blocked and the vehicle speed of the overtaking is quick, the behind vehicle is likely to collide with another vehicle, which is approaching from an opposite direction, in the process of overtaking.

### SUMMARY

In view of this, an embodiment of the present disclosure provides a device and method for managing internet of vehicles, and a vehicle using the device for managing internet of vehicles.

An embodiment of the present disclosure provides a device for managing internet of vehicles, applied in a first vehicle, including a first receiver and a first transmitter, wherein:

the first receiver is configured to receive a traffic request signal for requesting traffic data of the first vehicle from a second vehicle;

the first transmitter is connected to the first receiver, and is configured to send the traffic data corresponding to real-time traffic information acquired by a traveling recording device of the first vehicle to the second vehicle, such that the second vehicle can perform a corresponding operation based on the traffic data.

Further, an embodiment of the present disclosure also relates to a device for managing internet of vehicles, applied in a second vehicle, including a second receiver and a second transmitter, wherein:

the second transmitter is configured to send a traffic request signal for requesting traffic data from the second vehicle to a first vehicle;

the second receiver is configured to receive traffic data returned from the first vehicle in response to the traffic request signal, the traffic data being obtained in accordance with real-time traffic information acquired by a traveling recording device of the first vehicle. Thus the second vehicle can perform a corresponding operation based on the traffic data.

Further, an embodiment of the present disclosure provides a method for managing internet of vehicles, including:

receiving a traffic request signal for requesting traffic data of the first vehicle from a second vehicle; and

sending the traffic data corresponding to a real-time traffic information acquired by a traveling recording device of the first vehicle to the second vehicle, such that the second vehicle can perform a corresponding operation based on the traffic data.

An embodiment of the present disclosure also relates to a vehicle, including a traveling recording device and a device for managing internet of vehicles. The device for managing internet of vehicles includes a receiver and a transmitter, and the transmitter is connected to the receiver. The receiver is configured to receive a first traffic request signal, or receive real-time traffic information returned in response to a second traffic request signal sent by the transmitter. The transmitter is configured to send the second traffic request signal, or send traffic data corresponding to real-time traffic information acquired by the traveling recording device in response to the first traffic request signal.

### BRIEF DESCRIPTION OF THE DRAWINGS

FIG. 1 is a structural schematic diagram of a device for managing internet of vehicles according to an embodiment of the present disclosure;

FIG. 2 is a structural schematic diagram of a device for managing internet of vehicles according to an embodiment of the present disclosure;

FIG. 3 is a schematic flow diagram of a method for managing internet of vehicles according to an embodiment of the present disclosure; and

FIG. 4 is a schematic flow diagram of a method for managing internet of vehicles according to an embodiment of the present disclosure.

### DETAILED DESCRIPTION

The technical problems to be solved, technical solutions and advantages of the present disclosure will become more apparent from the following detailed description when taken in conjunction with the accompanying drawings and specific embodiments.

In order to provide front traffic information to a vehicle which is about to overtake, a display screen can be disposed at a rear side of a front vehicle so that a behind vehicle can obtain the view in front of the front vehicle at any time through the display screen of the front vehicle. However, this solution also has shortcomings. First, the front vehicle needs to have enough space to dispose the display screen at the rear side. Second, the display screen needs to be large enough so that people in the behind vehicle can clearly observe the content displayed on the display screen. However a larger screen is more expensive. Third, the front vehicle always displays the front traffic condition, regardless of whether there is a vehicle behind which is about to overtake, which can lead to waste of resources.

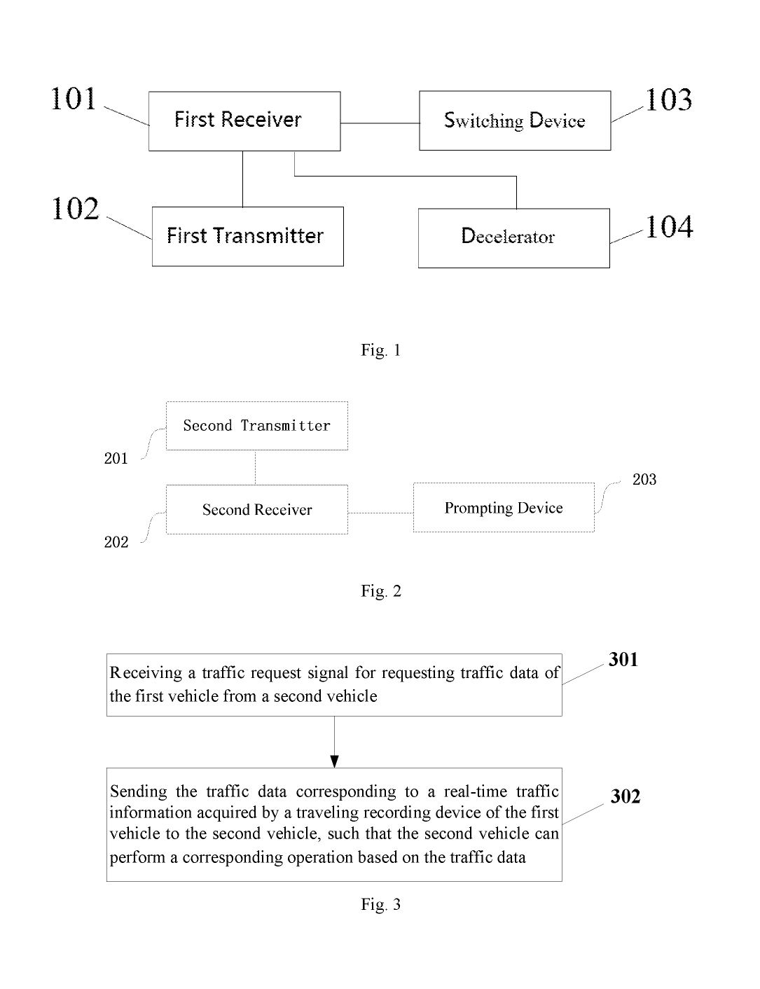

In order to effectively provide the front traffic information to the vehicle which is about to overtake, an embodiment of the present disclosure firstly provides a device for managing internet of vehicles, applied in a first vehicle, shown in FIG. 1. The device includes a first receiver 101 and a first transmitter 102.

The first receiver 101 is configured to receive a traffic request signal for requesting traffic data of the first vehicle from a second vehicle.

The first transmitter 102 is connected to the first receiver, and is configured to send the traffic data corresponding to real-time traffic information acquired by a traveling recording device of the first vehicle to the second vehicle, such that the second vehicle can perform a corresponding driving operation based on the traffic data.

As can be seen from the above, the device for managing internet of vehicles provided in an embodiment of the present disclosure is applied in the first vehicle. When the device receives the traffic request signal from the second vehicle, the device can obtain the traffic to be encountered by the first vehicle in real time and send it to the second vehicle in real time, which can facilitate the second vehicle to obtain the traffic information blocked by the first vehicle ahead as needed, and can facilitate the second vehicle to make a judgment on the upcoming overtaking and other lane changing behaviors.

Further, the device for managing internet of vehicles provided in an embodiment of the present disclosure can also be applied to autopilot vehicles.

In a specific embodiment of the present disclosure, the first transmitter 102 sends an operation of the traffic data corresponding to the real-time traffic information obtained by the traveling recording device of the first vehicle to the second vehicle, which is performed only when the traffic request sent by the second vehicle is received. Thus, the first vehicle does not need to continuously deliver the traffic data in a broadcast or other ways, thus avoiding the waste of energy caused by the continuous delivery of the traffic data without the request of others.

In a specific embodiment of the present disclosure, the traffic request signal can be the traffic request signal sent by the second vehicle for requesting the traffic data in any cases, which is not necessarily requested by the second vehicle for overtaking. In actual application, the second vehicle requests the traffic data corresponding to the traffic information obtained by the first vehicle in overtaking, thus effectively obtaining the front traffic information and improving the traffic safety.

In a specific embodiment of the present disclosure. The traffic information can be obtained by a traveling recording device having vehicle driving history recording function such as an in-vehicle camera or a traveling recorder of the first vehicle. The traffic data is the real-time traffic information such as an image or a video obtained by the traveling recording device; or data obtained by analyzing the image or video, such as traffic density or vehicle distance in front or the like.

The second vehicle is intended to perform operations such as overtaking, avoidance and so on.

In some embodiments of the present disclosure, still referring to FIG. 1, the device for managing internet of vehicles further includes a switching device 103.

The switching device 103 is connected to the first receiver 101, and is configured to turn on the traveling recording device of the first vehicle when the first receiver 101 receives the traffic request signal from the second vehicle.

In practice, some vehicle users will keep the traveling recording device operating throughout the course of the driving, and other vehicle users will turn on the traveling recording device as needed to save energy. In the latter case, when the traffic request signal is received, the first vehicle may not have obtained the traffic information. At this time, the traveling recording device needs to be turned on by the switching device to obtain the real-time traffic information.

In some embodiments of the present disclosure, the traffic data is the real-time traffic information, or an analysis result obtained by analyzing the traffic information. The analysis result may specifically indicate overtaking feasibility, traffic safety or the like.

Since in most cases, the second vehicle needs to obtain the traffic data recorded by the first vehicle only when the second vehicle is intended to overtake the first vehicle, the traffic data may be the analysis result obtained by analyzing the traffic information, which can be applicable to the needs of most traffic data requesters.

In a specific embodiment of the present disclosure, considering that it may not be convenient for the user of the second vehicle to pay full attention to observe the traffic video or the traffic pictures sent by the first vehicle during driving, the traffic video or the traffic pictures may be firstly analyzed to obtain the analysis result, such as the number of vehicles, the nearest vehicle distance, the vehicle speed estimate or the like in the front observation range. The analysis result is sent to the second vehicle to facilitate the second vehicle to obtain an intuitive traffic from the analysis result.

In some embodiments of the present disclosure, when the traffic data is the real-time traffic information, the first transmitter is a wireless communication signal transmitter.

When the traffic data is the real-time traffic information, the real-time traffic information is generally recorded in a form of an image or a video. In this case, in order to facilitate the user of the second vehicle to view the real-time traffic information, the real-time traffic information is best sent to the second vehicle, such that it is convenient for the user of the second vehicle to view the information. A wireless transmitter is employed such that the real-time traffic information may be transmitted to the second vehicle using Bluetooth, wireless communication network and so on.

In some embodiments of the present disclosure, when the traffic data is an analysis result obtained by analyzing the traffic information, such as an analysis result of overtaking feasibility, the first transmitter is a wireless communication signal transmitter, an optical signal transmitter or a voice signal player.

The analysis result of overtaking feasibility may be an answer to the judgment of whether or not it is suitable for overtaking, or may also be a value indicating a degree of overtaking feasibility, for example, the degree of overtaking feasibility is 50%. When the traffic data is an analysis result obtained by analyzing the traffic information, the traffic data may be transmitted to the second vehicle by the wireless communication signal transmitter. Different optical signals may be sent by the optical signal transmitter to indicate whether it is suitable for overtaking or the degree of overtaking feasibility. For example, a red light signal indicates that it is not suitable for overtaking. A green light signal indicates that it is suitable for overtaking. Or different voice signals may be sent by the voice signal transmitter to indicate whether it is suitable for overtaking or the degree of overtaking feasibility. For example, “please move on” or “please do not overtake” is played to the second vehicle behind.

In some embodiments of the present disclosure, the first receiver is further configured to receive an overtaking signal indicating that the second vehicle is certainly about to overtake.

Still referring to FIG. 1, the device further includes a decelerator 104.

The decelerator 104 is connected to the first receiver 101, and controls the first vehicle to be decelerated when the first receiver 101 receives the overtaking signal indicating that the second vehicle is certainly about to overtake.

When the second vehicle is determined to perform an overtaking operation, the speed of the first vehicle can be automatically reduced by the decelerator, thereby facilitating the second vehicle to overtake and creating a friendly driving environment.

Further, an embodiment of the present disclosure also provides a device for managing internet of vehicles, applied in a second vehicle, as shown in FIG. 2, which includes a second receiver 202 and a second transmitter 201.

The second transmitter 201 is configured to send a traffic request signal for requesting traffic data from the second vehicle to a first vehicle.

The second receiver 202 is configured to receive traffic data returned from the first vehicle in response to the traffic request signal, wherein the traffic data is obtained in accordance with real-time traffic information acquired by a traveling recording device of the first vehicle, such that the second vehicle can perform a corresponding driving operation based on the traffic data.

When a user of the second vehicle wishes to obtain the traffic data which is acquired by the first vehicle, the device for managing internet of vehicles provided in an embodiment of the present disclosure can send the traffic request signal for requesting the traffic data, which facilitates the user of the second vehicle to obtain the traffic data before overtaking or in other cases where the traffic data obtained by the first vehicle needs to be used, and to perform a corresponding driving operation based on the traffic data.

In a specific embodiment of the present disclosure, the traffic request signal may be sent when the user of the second vehicle wishes to overtake the first vehicle, or may be sent when the user of the second vehicle needs the real-time traffic data recorded by the first vehicle.

In some embodiments of the present disclosure, the traffic request signal includes an overtaking signal, an avoidance signal or a danger warning signal.

In some embodiments of the present disclosure, the traffic data is the real-time traffic information, or an analysis result obtained by analyzing the traffic information.

When the traffic data is the real-time traffic information, the second receiver is a wireless communication signal receiver. When the traffic data is the analysis result obtained by analyzing the traffic information, the second receiver is a wireless communication signal receiver, an optical signal receiver, or a voice signal receiver.

In some embodiments of the present disclosure, still referring to FIG. 2, the device for managing internet of vehicles further includes a prompting device 203.

The prompting device 203 is configured to prompt a corresponding signal to a user of the second vehicle in accordance with the traffic data received by the second receiver 202, such that the user can directly obtain a traffic indicated by the traffic data from the signal.

When the second receiver is an optical signal receiver or a voice signal receiver, the user may be confused about the contents indicated by an optical signal or a voice signal. Or, when the rules are more complex, the user may forget the meaning of different optical signals or voice signals. Therefore, the device for managing internet of vehicles further includes a prompting device, which is configured to prompt a corresponding signal to the user of the second vehicle in accordance with the information received by the optical signal receiver or the voice signal receiver.

When the second receiver is a wireless communication signal receiver, the traffic data may be a traffic picture or a traffic video obtained in real time. In this case, in order to assist the user of the second vehicle to make a decision on the upcoming driving operation, the user may be prompted based on the results obtained by analyzing the traffic data.

In particular, the prompting device may be a sound player or a display.

In some embodiments of the present disclosure, the second transmitter is further configured to send an overtaking signal to the first vehicle when it is determined that the second vehicle is about to overtake.

When the user of the second vehicle decides to perform the action of overtaking the first vehicle, the overtaking signal may be sent to the first vehicle via the second transmitter, such that the first vehicle may be decelerated or know that the second vehicle is about to overtake.

In a specific embodiment of the present disclosure, the first vehicle and the second vehicle may communicate with each other through a network, and the second vehicle may obtain the image of the view of the first vehicle through such network before overtaking. The device for managing internet of vehicles disposed in the second vehicle or the first vehicle reminds the driver of the second vehicle whether to overtake or not based on the image information, to ensure driving safety. The specific implementation may be as follows. The first vehicle is provided with a front traveling recording device, which may be a traveling recorder, an in-vehicle camera or the like. The first transmitter includes a wireless transmitting device, which may send the information recorded in the traveling recording device to nearby vehicles. When the user of the second vehicle plans to overtake while approaching the first vehicle, the user may send a traffic request to the first vehicle via the second transmitter, and when the first receiver of the first vehicle receives such request, traffic information is sent to the second vehicle via the wireless transmitting device.

In another specific embodiment of the present disclosure, the first vehicle and the second vehicle may communicate with each other through a network. The second vehicle may obtain the image of the view of the first vehicle through such network before overtaking. The device for managing internet of vehicles disposed in the second vehicle or the first vehicle reminds the driver of the second vehicle whether to overtake or not based on the image information, to ensure driving safety. When the user of the second vehicle decides to overtake, the user may send an overtaking signal to the first vehicle via a second transmitter. When the first receiver of the first vehicle receives the overtaking signal, the decelerator of the first vehicle may reduce the driving speed of the first vehicle. The specific implementation may be as follows. The first vehicle is provided with a front traveling recording device, which may be a traveling recorder, an in-vehicle camera or the like. The first transmitter includes a wireless transmitting device, which may send the information recorded in the traveling recording device to nearby vehicles. When the user of the second vehicle plans to overtake while approaching the first vehicle, the user may send a traffic request to the first vehicle via the second transmitter, and when the first receiver of the first vehicle receives such request, traffic information is sent to the second vehicle via the wireless transmitting device. The second vehicle may send the overtaking signal to the first vehicle by a wireless signal or an optical signal. If the optical signal is used, for example, a high beam and a low beam are flashing at a fixed frequency, the first receiver further includes a light receiving device.

In another specific embodiment of the present disclosure, the first vehicle and the second vehicle may communicate with each other through a network. The second vehicle may obtain the image of the view of the first vehicle through such network before overtaking. The device for managing internet of vehicles disposed in the second vehicle or the first vehicle reminds the driver of the second vehicle whether to overtake or not based on the image information, to ensure driving safety. The specific implementation may be as follows. The first vehicle is provided with a front traveling recording device, which may be a traveling recorder, an in-vehicle camera or the like. The first transmitter includes a wireless transmitting device, which may send the information recorded in the traveling recording device to nearby vehicles. When the user of the second vehicle plans to overtake while approaching the first vehicle, the user may send a traffic request to the first vehicle via the second transmitter. When the first receiver of the first vehicle receives such request, traffic information is sent to the second vehicle via the wireless transmitting device. The first vehicle also has an analyzing device such as a circuit having an analyzing function. When the first receiver receives the traffic request, the analyzing device analyzes the traffic information. If the traffic is not suitable for overtaking, a signal indicating that it is not suitable for overtaking is sent to the second vehicle via the wireless transmitting device. Such signal may also be transmitted through a special optical signal, such as red light. If the traffic is suitable for overtaking, the first transmitter sends a signal indicating that it is possible to overtake to the behind vehicle, and the first vehicle is decelerated by the decelerator.

Further, the present disclosure provides a method for managing internet of vehicles, including steps shown in FIG. 3.

At step 301, a traffic request signal for requesting traffic data of the first vehicle is received from a second vehicle.

At step 302, the traffic data corresponding to a real-time traffic information acquired by a traveling recording device of the first vehicle is sent to the second vehicle, such that the second vehicle can perform a corresponding driving operation based on the traffic data.

In some embodiments of the present disclosure, the method further includes:

receiving an overtaking signal indicating that the second vehicle is certainly about to overtake the first vehicle; and

reducing a traveling speed of the first vehicle.

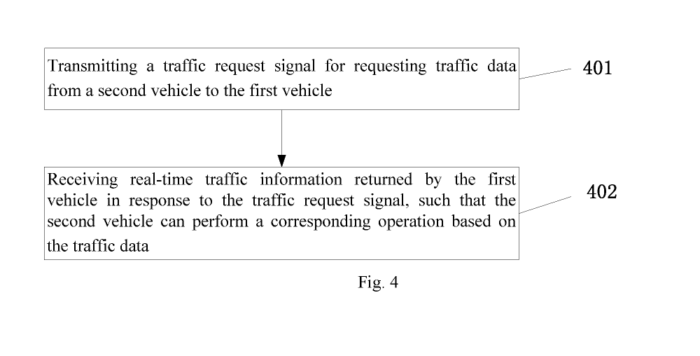

Further, an embodiment of the present disclosure also provides a method for managing internet of vehicles, including steps shown in FIG. 4.

At step 401, a traffic request signal for requesting traffic data of a first vehicle is transmitted to the first vehicle.

At step 402, real-time traffic information returned from the first vehicle in response to the traffic request signal is received, such that the second vehicle can perform a corresponding driving operation based on the traffic data.

In some embodiments of the present disclosure, the method further includes:

sending an overtaking signal to the first vehicle when it is determined that the second vehicle is about to overtake.

As can be seen from the above, when the second vehicle is intended to overtake the first vehicle and when the traffic data viewed and acquired at a position where the first vehicle is located is needed, the device and method for managing internet of vehicles provided by an embodiment of the present disclosure can send a traffic request signal to the first vehicle and obtain real-time traffic data acquired by a traveling recording device of the first vehicle, which facilitates the user to make a judgment or decision on a driving operation to be performed and improves the safety of vehicle driving. In an embodiment of the present disclosure, the traffic data can be sent to the second vehicle, such that the second vehicle is capable of observing the traffic data or obtaining an analysis result of the traffic data by means of a display device of the second vehicle itself or according to an indicative optical signal (such as a red light for indicating a possible continuous operation, and a green light for indicating an unallowable operation) or an indicative voice signal. Further, in an embodiment of the present disclosure, the traffic data is sent to the second vehicle only when the second vehicle sends a traffic request signal, thereby realizing the energy saving and the information utilization rate.

It is to be understood that the various embodiments described in this specification are for the purpose of illustration and explanation only, and are not intended to be limiting of the present disclosure. The embodiments and the features in the embodiments in the present application may be combined with each other without conflict.

It will be apparent to those skilled in the art that various modifications and changes can be made in this disclosure without departing from the spirit and scope of the present disclosure. In this way, the present disclosure is intended to embrace such modifications and variations if these modifications and variations of this disclosure are within the scope of the present disclosure and the equivalents thereof.

1. A device for managing internet of vehicles, applied in a first vehicle, comprising a first receiver and a first transmitter, wherein
the first receiver is configured to receive a traffic request signal for requesting traffic data of the first vehicle from a second vehicle;
the first transmitter is connected to the first receiver, and is configured to send the traffic data corresponding to real-time traffic information acquired by a traveling recording device of the first vehicle to the second vehicle.

2. The device for managing internet of vehicles of claim 1 further comprises a switching device, wherein
the switching device is connected to the first receiver, and is configured to turn on the traveling recording device of the first vehicle when the first receiver receives the traffic request signal.

3. The device for managing internet of vehicles of claim 1, wherein the traffic request signal comprises at least one of an overtaking signal, an avoidance signal, and a danger warning signal.

4. The device for managing internet of vehicles of claim 1, wherein the traffic data comprises the real-time traffic information, or an analysis result obtained by analyzing the traffic information.

5. The device for managing internet of vehicles of claim 1, wherein the first transmitter comprises a wireless communication signal transmitter, an optical signal transmitter, or a voice signal player.

6. The device for managing internet of vehicles of claim 1, wherein the first receiver is further configured to receive an overtaking signal indicating that the second vehicle is certainly about to overtake,
the device for managing internet of vehicles further comprises a decelerator,
the decelerator is configured to control the first vehicle to be decelerated when the first receiver receives the overtaking signal.

7. A device for managing internet of vehicles, applied in a second vehicle, comprising a second receiver and a second transmitter,
wherein the second transmitter is configured to send a traffic request signal for requesting traffic data from the second vehicle to a first vehicle; and
the second receiver is configured to receive traffic data returned from the first vehicle in response to the traffic request signal, the traffic data being obtained in accordance with real-time traffic information acquired by a traveling recording device of the first vehicle.

8. The device for managing internet of vehicles of claim 7, wherein the traffic request signal comprises at least one of an overtaking signal, an avoidance signal and a danger warning signal.

9. The device for managing internet of vehicles of claim 7, wherein the traffic data comprises the real-time traffic information, or an analysis result obtained by analyzing the traffic information,
the second receiver comprises a wireless communication signal receiver, an optical signal receiver, or a voice signal receiver.

10. The device for managing internet of vehicles of claim 9, wherein the device for managing internet of vehicles further comprises a prompting device,
the prompting device is configured to prompt a corresponding signal to a user of the second vehicle in accordance with the traffic data received by the second receiver.

11. The device for managing internet of vehicles of claim 7, wherein the second transmitter is further configured to send an overtaking signal to the first vehicle when it is determined that the second vehicle is about to overtake.

12-15. (canceled)

16. A vehicle, comprising:
a traveling recording device; and
a device for managing internet of vehicles,
wherein the device for managing internet of vehicles comprises a receiver and a transmitter, and the transmitter is connected to the receiver,
wherein the receiver is configured to receive a first traffic request signal, or receive real-time traffic information returned in response to a second traffic request signal sent by the transmitter,
the transmitter is configured to send the second traffic request signal, or send traffic data corresponding to real-time traffic information acquired by the traveling recording device in response to the first traffic request signal.

17. The vehicle of claim 16, wherein the device for managing internet of vehicles further comprises a switching device, which is connected to the receiver and configured to turn on the traveling recording device when the receiver receives the first traffic request signal.

18. The vehicle of claim 16, wherein the transmitter comprises a wireless communication signal transmitter, an optical signal transmitter or a voice signal player, and the receiver comprises a wireless communication signal receiver, an optical signal receiver or a voice signal receiver.

19. The vehicle of claim 16, wherein the receiver is further configured to receive an overtaking signal,
the device for managing internet of vehicles further comprises a decelerator, which is configured to control the vehicle to be decelerated when the receiver receives the overtaking signal.

20. The vehicle of claim 16, wherein the device for managing internet of vehicles further comprises a prompting device.
